(19) United States
(12) Patent Application Publication
(10) Pub. No.: US 2019/0246627 A1
(43) Pub. Date: Aug. 15, 2019

(54) Automated Decoy System

(71) Applicant: WiSys Technology Foundation, Inc., Madison, WI (US)

(72) Inventors: Jordan Frentz, Racine, WI (US); Melanie Dritlein, Brookfield, WI (US); Maxwell Sagen, Waukesha, WI (US); Nathan VanSchaick, Waukesha, WI (US); Derek Lubecke, Yorkville, IL (US)

(21) Appl. No.: 16/273,546

(22) Filed: Feb. 12, 2019

Related U.S. Application Data
(60) Provisional application No. 62/629,414, filed on Feb. 12, 2018.

(51) Int. Cl. A01M 31/06

(52) U.S. Cl. CPC A01M 31/06

(57) ABSTRACT

A floating duck decoy system is provided that facilitates the deployment and retrieval of the duck decoys by automated robots with position and touch sensing capabilities. The robots can be freely arranged and repositioned through user manipulation and computer control. The automated robots allow the duck decoys to mimic swarm behavior, where movement and interaction of groups of animals operate according to simple rules. Therefore, nonlinear spread formations provide more realistic movement of the duck decoys.

### CROSS REFERENCE TO RELATED APPLICATION

This application claims the benefit of U.S. Provisional Application No. 62/629,414, filed Feb. 12, 2018, hereby incorporated by reference.

### STATEMENT REGARDING FEDERALLY SPONSORED RESEARCH OR DEVELOPMENT

- - -

### BACKGROUND OF THE INVENTION

The present invention relates to a floating duck decoy system resembling a flock or spread of ducks floating on the water while providing automated setup with easy deployment and retrieval of the ducks from the water.

Lifelike duck decoys are commonly used on the water for hunting game birds such as ducks and geese. The presence of duck decoys in the water may encourage game birds to fly over and land in the water.

Duck decoys are most often placed in cold and mucky waters such as rivers and lakes during cold weather months. Therefore, they must be made of freeze and impact proof bodies. Moreover, spread techniques help flyover birds to see the decoys from further away. For example, groupings of birds resemble patterns of real ducks when they feed, rest, and paddle.

Spreads of duck decoys are typically tied together for easier deployment and retrieval into the cold and murky water. Duck decoy pre-existing spread systems utilize underwater posts employed to allow duck decoys to move in a linear formation.

### SUMMARY OF THE INVENTION

The present inventors have recognized that the deployment and retrieval of floating duck decoys may be facilitated by automated robots with position and touch sensing capabilities. The robots can be freely arranged and repositioned through user manipulation and computer control. The automated robots allow the duck decoys to mimic “swarm” behavior where movement and interaction of groups of animals operate according to simple rules. Therefore, nonlinear spread formations provide more realistic movement of the duck decoys.

The duck decoys may be self-propelled by many autonomous mini robots using “swarm” user interfaces that move the robots collectively and react to user input. The mini robots able to freely and quickly reconfigure themselves spatially in response to user input.

In one embodiment, the present invention may be an aquatic bird decoy system including at least two bird decoys each having a body element sized and anatomically decorated to resemble a bird wherein the body element is buoyant in water; at least one pulley and line extending between the at least two bird decoys to provide a variable constrained separation; at least one propeller for moving the body elements; at least one electric motor communicating with the at least one pulley and propeller to move the body element in water within the constrained separation; and a wireless communication device communicating with the at least electric motor for controlling operation of the electric motor.

It is thus a feature of at least one embodiment of the invention to mimic “swarm” movement of a flock or spread of floating ducks in water.

Each of the bird decoy systems may include a pulley and line, propeller, and electric motor independently controlled to produce formations of the at least two bird decoys.

It is thus a feature of at least one embodiment of the invention to use small and lightweight motors attached to the floating body elements to provide movement of the pulley and line connected bird decoys.

The wireless communication device may operate the at least one electric motor to move the at least two bird decoys between a first position where the at least two bird decoys are expanded away from each other and a second position where the at least two bird decoys are contracted toward each other.

It is thus a feature of at least one embodiment of the invention to use contracted movement of the bird decoys to make collection of the bird decoys from the water easier.

Movement of the at least two bird decoys may be programmable to designate a first constrained position of each bird decoy, a second constrained position of each bird decoy, and a third constrained position of each bird decoy each providing successively greater permissible separation between the at least two bird decoys.

It is thus a feature of at least one embodiment of the invention to provide a wide dispersion of duck decoys over a large body of water in non-linear movements.

The line may be connected to a ring connector of each bird decoy.

It is thus a feature of at least one embodiment of the invention to allow for quick connection of each bird decoys to a common line and to each other.

The wireless communication device may communicate via Bluetooth. The wireless communication device may communicate via Wi-Fi.

It is thus a feature of at least one embodiment of the invention to control the bird decoys from a remote location.

The wireless communication device may be a mobile phone.

It is thus a feature of at least one embodiment of the invention to allow the bird decoys to be controlled by a mobile phone application over Bluetooth where internet connectivity may be limited.

There may be a separate motor for the at least one propeller and for the at least one pulley and line.

The electric motor may be a permanent magnet DC motor.

In another embodiment the present invention provides a method of operating an aquatic bird decoy system including the steps of: providing at least two bird decoys each having a body element sized and anatomically decorated to resemble a bird wherein the body element is buoyant in water; at least one pulley and line extending between the at least two bird decoys to provide a variable constrained separation; at least one propeller for moving the body elements; at least one electric motor communicating with the at least one pulley and propeller to move the body element in water within the constrained separation; and a wireless communication device communicating with the at least electric motor for controlling operation of the electric motor; and wirelessly communicating with the at least one electric motor to operate the at least one propeller of the at least two bird decoys to control movement of the at least two bird decoys in water.

It will be appreciated that the teachings of the present invention may be applied to other floating devices such as water buoys, life preserver rings, fishing bobbers or the like that may be dispersed within the water in desired formations but easily retrievable when prompted.

These particular objects and advantages may apply to only some embodiments falling within the claims and thus do not define the scope of the invention.

### BRIEF DESCRIPTION OF THE DRAWINGS

FIG. 1 is a perspective view of a plurality of floating duck decoys for use with the present invention the duck decoys coupled together using snap swivels and a nylon line attached to an anchor;

FIG. 2 is a side view of one floating duck decoy of FIG. 1 floating on the water and being self-propelled by a mini robot and swarm user interface;

FIG. 3 is a figure showing a spread of floating duck decoys in an expanded spread formation;

FIG. 4 is a figure showing the spread of floating duck decoys of FIG. 3 in a retracted formation for easier duck decoy retrieval;

FIG. 5 is a figure showing a spread of floating duck decoys connected by a common line and pulley system; and

FIG. 6 is a diagram showing communication of the mini robot with a motor operating at least one of a propeller, pulley, anchor and rudder.

### DETAILED DESCRIPTION OF THE PREFERRED EMBODIMENT

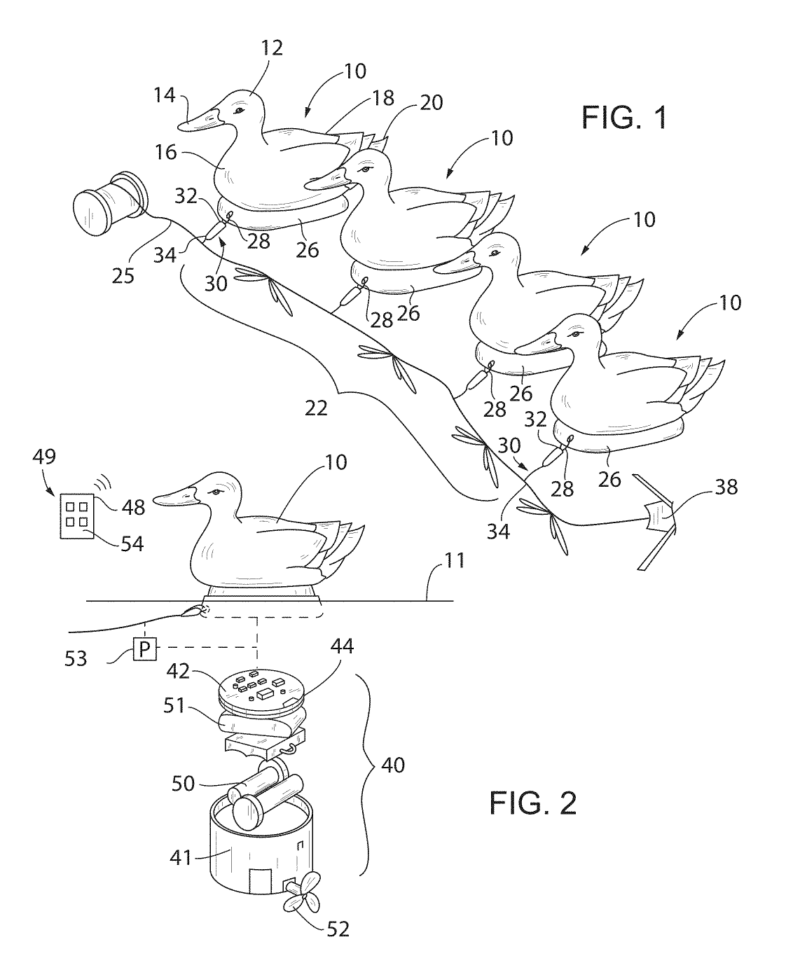

Referring now to FIGS. 1 and 2, a plurality of duck decoys 10 may resemble a real-life duck floating in the water 11 and providing anatomically correct parts such as a head 12 with a bill 14, a body 16 having wings 18, and a tail 20. The body 16 may be floatable and oversized to better allow flyover game birds to see the duck decoys 10. For close-up realism, the duck decoys 10 may include motion controlled operation such as movement of the wings or water agitators to provide swimming motion or splashing.

The duck decoys 10 may be constructed of plastic material allowing them to be freeze and impact proof. The construction may also be of a material such that the duck decoys 10 do not make a loud sound when knocked together during transport. The duck decoys 10 are realistically painted to resemble a particular sex or species of duck. For example, the duck decoys 10 may resemble the particular colors and patterns of male mallards (drakes) or female mallards (hens). The duck decoys 10 may also be any of the following species including but not limited to pin tales, black ducks, green winged teal, Canada geese, wood ducks, canvasback's, redheads, and coots.

Referring to FIG. 1, a plurality of duck decoys 10 may be coupled together to form a spread 22. The spread 22 provides better realism to the placement of duck decoys 10 in the water 11 by placing groups of duck decoys 10 together. Not only are the spreads 22 easier for flyover game birds to see but they provide more realistic movement patterns of real life ducks.

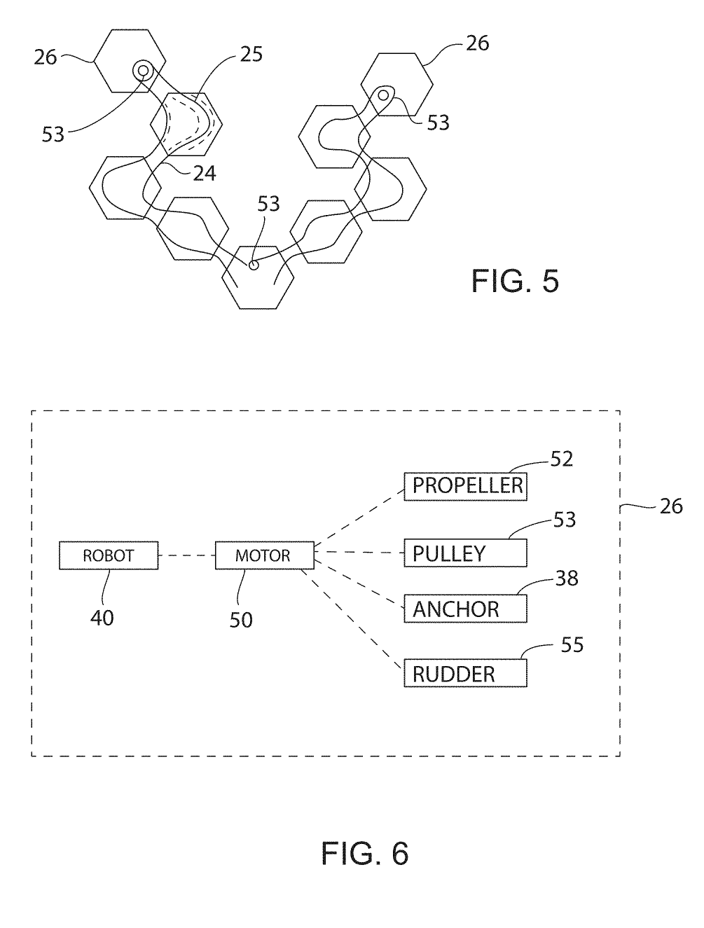

The spreads 22 of duck decoys 10 may be created by coupling each of the duck decoys 10 to a common line 24. For example, the body 16 of the duck decoy 10 may be supported on a base 26 having a front attachment ring 28 carrying a hole receiving a trot line snap swivel 30 having a first end 32 attached to the front attachment ring 28 and a second end 34 attached to the common line 24 and the first end 32 swivels with respect to the second end 34. Alternatively, the common line 24 may run through a slot or tubing 25 on the base 26 (see FIG. 5). The common line 24 may run through each of the duck decoys 10 that are a part of the same spread 22. The common line 24 may also run through a pulley 53 as further described below.

An end 36 of the common line 24 may be attached to an anchor 38 or weight which tethers the end common line 24 to a stationary location which may be reeled in by the user. The anchor 38 may include a manual or automated reel by which to retrieve the duck decoys 10 after hunting. Each duck decoy 10 may also supports its own individual anchor 38 that is raised or lowered into the water to retain each duck decoy 10 in a stationary location.

Although the common line 24 is shown tied up, for example, during set up, it is understood that any length of line 24 may be used between duck decoys 10 as desired and may be lengthened and shortened by the pulley 53. The common line 24 may be a braided nylon line.

Referring to FIG. 2, each of the duck decoys 10 included in the common spread 22 may include a self-propelled mini robot 40 which provides movement of each duck decoy 10 in the water 11 as part of a collectively moving “swarm” that reacts to user input. The mini robot 40 may be carried by the base 26 of the duck decoy 10 within a robot housing 41. The robot housing 41 may be a cylindrical enclosure having an enclosed top and bottom and carrying a number of components as described below. The robot housing 41 may be smaller in size than the base 26, for example, approximately 2 to 3 cm in diameter and 2 to 3 cm in length. The mini robot 40 may be lightweight, for example, under 15 grams, such that it does not affect the floating characteristics of the duck decoy 10.

It is understood that the base 26 and/or the robot housing 41 may be waterproof to prevent seepage of water into the electronic components. The base 26 and/or robot housing 41 may be attached to preexisting duck decoys 10, for example, the base 26 and/or robot 41 may have an upper cavity receiving a decoy keel of a preexisting duck decoy 10.

The robot housing 41 of each of the mini robots 40 may include a power circuit board 42 providing robotic control. For example, the mini robots 40 may have a 48 MHz ARM microcontroller (STMicroelectronics STM32F051C8) that manages the logic computation and communicates wirelessly with a main master computer using a 2.4 GHz radio chip (Nordic nRF24L01+). The mini robot 40 may include a radio receiver 44 receiving radio waves from a user device such as a mobile device and converting the information to be received by the 2.4 GHz radio chip of the power circuit board 42. In one embodiment of the invention, radio waves may be transmitted from a radio transmitter 48 of a remote device 49 to the radio receiver 44 and power circuit board 42 of the mini robot 40 to control movement of the mini robot 40. It is understood that the radio receiver 44 and/or radio transmitter 48 may be a wireless (WiFi) modem, a Bluetooth modem, or other long-range or short-range communication device.

Referring also to FIG. 6, the mini robot 40 may be powered by a battery 51, for example, a 100 mAh LiPo battery which drives at least one motor 50 communicating with motor driven propeller 52, pulley 53, anchor 38 and rudder 55 to turn the propeller 52 on and off, to operate the pulley 53 to expand and retract the spread 22 of duck decoy 10, and to raise and lower the anchor 38. The mini robot 40 may also be used to direct the rudder 55 straight, left and right. The battery 51 may be charged through a wired or wireless charging method.

The motor driven propeller 52 may be driven by a motor driver chip to rotate a fan about a generally horizontal rotation axis to displace water and allow for generally horizontal movement of the duck decoy 10 in the water as known in the art. Alternatively, the motor driven propeller 52 may be a water pump in-taking and expelling water to propel the dock decoy 10 in a generally horizontal forward and/or rearward direction.

Referring also to FIG. 5, the motor driven pulley 53 may control the length of common line 24 between decoy ducks 10 by rotating a motor driven wheel on an axel to wind and unwind the common line 24 to provide a variable constrained separation as understood in the art. The pulley 53 may also carried by the base 26 of at least one duck decoy 10 of the spread 22 of duck decoys 10 interconnected by a common line 24. Some of the duck decoys 10 may provide running of the common line 24 therethrough while other duck decoys 10 may contain a pulley 53 for winding and unwinding of the common line 24.

It is understood that the motor driven propeller 52, and pulley 53, anchor 38 and rudder 55 may be driven by the same or separate motors 50. It is understood that the motor 50 may be piezo actuators.

The mini robot 40 may be able to react to position and user input. In one embodiment of the invention, optical tracking of each mini robot 40 may be accomplished using an external projector. Other methods of position tracking include but are not limited to IR laser light beacons, wireless tracking, and dead reckoning location techniques.

The mini robot 40 may be constructed as described in “Zooids: Building Blocks for Swarm User Interfaces”, Mathieu Le Goc, Lawrence H. Kim, Ali Parsaei, Jean-Daniel Fekete, Pierre Dragicevic, Sean Follmer, UIST '16 Proceedings of the 29th Annual Symposium on User Interface Software and Technology, 2016, which may be found at http://shape.stanford.edu/research/swarm/, and is hereby incorporated by reference.

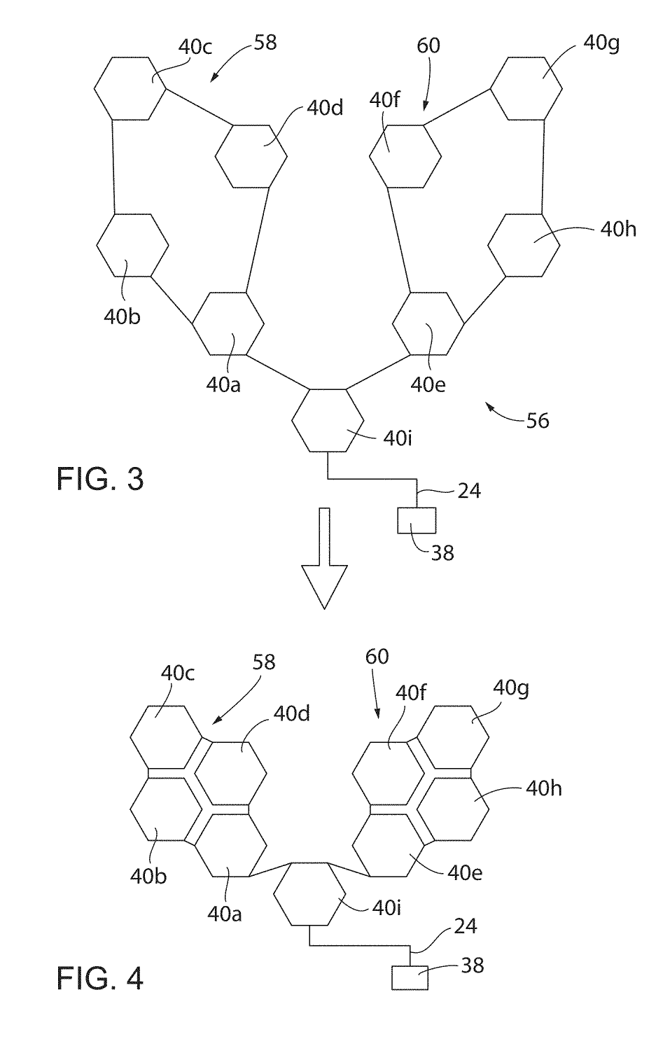

Referring now to FIGS. 3 and 4, the position of each mini robot 40 may be determined by a centralized user interface 54 of the remote device 49, which may be a remote computer or mobile device, and which designates positioning of each mini robot 40 individually or collectively as a swarm. For example, the user may be able to program a particular start, intermediate, and/or end position of each mini robot 40 having successively greater separation as permitted by the length of line 24 between duck decoys 10. In one embodiment of the present invention, the mini robot 40 may be assigned to move from a start position to an end position while avoiding collisions with other mini robots 40 during such movement.

Referring to FIG. 3, the spread 22 of duck decoys 10 may be programmed to move via the mini robots 40 to an expanded formation 56 whereby a first group 58 of mini robots 40a, 40b, 40c, 40d may be connected in a first circular formation, a second group 60 of mini robots 40e, 40f, 40g, 40h may be connected in a second circular formation, and the mini robot 40a of the first group 58 and the mini robot 40e of the second group 60 are connected to a mini robot 40i with the mini robot 40i tethered to the anchor 38 or a stationary location. In the expanded formation 56, the collective swarm of mini robots 40 may be programmed to spread out away from mini robot 40i while also forming the first circle and second circle which are spread out from each other. The expanded formation 56 is just one example of a configuration which can be taken by the spread 22 of duck decoys 10. For example, any attachment of duck decoys 10 with other duck decoys 10 may be used to connect the spread 22 of duck decoys 10. It may be desired to arrange the duck decoys 10 in natural evolving formations or configurations to mimic the swarm behavior of real-life ducks in the wild.

Referring to FIG. 4, when it is desired to retrieve the spread 22 of duck decoys 10 from the water 11 the mini robots 40 may be programmed to move the mini robots 40a contracted formation 62 whereby the first group 58 of mini robots 40a, 40b, 40c, 40d form a first contracted circle and the second group 60 of mini robots 40e, 40f, 40g, 40h perform a second contracted circle. The first circle and second circle also move closer to the mini robot 40i so that the duck decoys 10 are clumped together for easy retrieval out of the water 11. In the contracted formation 62, this collective swarm of mini robots 40 may be programmed to clump together. The contracted formation 62 is just one example of a configuration which may be taken by the spread 22 of duck decoys 10 during retrieval.

In use, the spread 22 of duck decoys 10 may be placed into the water 11. The user interface 54 of the remote device 49 may be used to program and/or select a desired movement of the duck decoys 10, for example, selecting the first expanded formation 56. The mini robots 40 will automatically move to the programmed location. Any number of formations may be selected or may be run in a manual or automatic sequence to provide natural movements of the spread 22 of duck decoys 10.

When it is desired to collect the spread 22 of duck decoys 10 from the water 11, the user interface 54 of the remote device 49 may be used to select the contracted formation 62 operating to move the mini robots 40 into a clumped formation and allowing the user to easily collect the duck decoys 10 from the water 11.

When collected in the particular attachment arrangement of duck decoys 10 as shown in FIGS. 3 and 4 the duck decoys are prevented from tangling.

It is understood that the mini robots 40 may be installed on pre-existing duck decoys 10 to convert pre-existing duck decoys 10 into automated, swarm-able duck decoys 10 as described herein.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a controller” and “a processor” should be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. An aquatic bird decoy system comprising:
at least two bird decoys each having a body element sized and anatomically decorated to resemble a bird wherein the body element is buoyant in water;
at least one pulley and line extending between the at least two bird decoys to provide a variable constrained separation;
at least one propeller for moving the body elements;
at least one electric motor communicating with the at least one pulley and propeller to move the body element in water within the constrained separation; and
a wireless communication device communicating with the at least electric motor for controlling operation of the electric motor.

2. The system of claim 1 wherein each of the bird decoy systems includes a pulley and line, propeller, and electric motor independently controlled to produce formations of the at least two bird decoys.

3. The system of claim 1 wherein the wireless communication device operates the at least one electric motor to move the at least two bird decoys between a first position where the at least two bird decoys are expanded away from each other and a second position where the at least two bird decoys are contracted toward each other.

4. The system of claim 1 wherein movement of the at least two bird decoys is programmable to designate a first constrained position of each bird decoy, a second constrained position of each bird decoy, and a third constrained position of each bird decoy each providing successively greater permissible separation between the at least two bird decoys.

5. The system of claim 1 wherein there is a separate motor for the at least one propeller and for the at least one pulley and line.

6. The system of claim 1 wherein the line is connected to a ring connector of each bird decoy.

7. The system of claim 1 wherein the at least one electric motor is a permanent magnet DC motor.

8. The system of claim 1 wherein the wireless communication device communicates via Bluetooth.

9. The system of claim 1 wherein the wireless communication device communicates via WiFi.

10. The system of claim 1 wherein the wireless communication device is a mobile phone.

11. A method of operating an aquatic bird decoy system comprising the steps of:
providing at least two bird decoys each having
a body element sized and anatomically decorated to resemble a bird wherein the body element is buoyant in water;
at least one pulley and line extending between the at least two bird decoys to provide a variable constrained separation;
at least one propeller for moving the body elements;
at least one electric motor communicating with the at least one pulley and propeller to move the body element in water within the constrained separation; and
a wireless communication device communicating with the at least electric motor for controlling operation of the electric motor;
wirelessly communicating with the at least one electric motor to operate the at least one propeller of the at least two bird decoys to control movement of the at least two bird decoys in water.

12. The method of claim 11 wherein the electric motor of each bird decoy is independently controlled by the wireless communication device.

13. The method of claim 11 further comprising moving the at least two bird decoys between a first position where the at least two bird decoys are expanded away from each other and a second position where the at least two bird decoys are contracted toward each other.

14. The method of claim 11 wherein movement of the at least two bird decoys is programmable to designate a first constrained position of each bird decoy, a second constrained position of each bird decoy, and a third constrained position of each bird decoy each providing successively greater permissible separation between the at least two bird decoys.

15. The method of claim 11 wherein there is a separate motor for the propeller and for the pulley.

16. The method of claim 11 wherein the line is attached to a ring connector of each bird decoy.

17. The method of claim 11 wherein the at least one electric motor is a permanent magnet DC motor.

18. The method of claim 11 wherein the wireless communication device communicates via Bluetooth.

19. The method of claim 11 wherein the wireless communication device communicates via WiFi.

20. The method of claim 11 wherein the wireless communication device is a mobile phone.
